(19) United States
(12) Patent Application Publication
(10) Pub. No.: US 2004/0168570 A1
(43) Pub. Date: Sep. 2, 2004

(54) Apparatus and process for separating purified methans

(76) Inventor: Johann Franek, Vienna (AT)

Correspondence Address: IP DEPARTMENT OF PIPER RUDNICK LLP, ONE LIBERTY PLACE, SUITE 4900, 1650 MARKET ST, PHILADELPHIA, PA, 19103, US

(21) Appl. No.: 10/483,303

(22) PCT Filed: Jul. 9, 2002
(86) PCT No.: PCT/EP02/07635

(30) Foreign Application Priority Data
Jul. 9, 2001 (AT) 1063/2001

(51) Int. Cl. B01D 53/22

(52) U.S. Cl. 95/50

(57) ABSTRACT

A process and a gas permeation apparatus for separating purified methane from hydrocarbons higher than C₁ in a feed gas mixture such as natural gas, naphtha, liquified natural gas (LNG), liquified petroleum gas (LPG), off gas from petrochemical industries and others, comprising at least one gas permeation module (1) with a feed gas inlet, an outlet for a gas stream (4) containing purified methane, an outlet for a gas stream (3) containing hydrocarbons higher than C₁ and a permselective membrane (1′) having a permeate side (4′) and a retentate side (3′), characterised in that said permselective membrane (1′) consists of glassy, amorphous or semi-crystalline polymers having a glass-transition temperature above the operating temperature of the gas permeation apparatus and that said outlet for the gas stream (4) containing purified methane is arranged on the permeate side (4′) of said permeselective membrane (1′).

The present invention relates to a gas permeation apparatus for separating purified methane from hydrocarbons higher than C₁ in a feed gas mixture such as natural gas, naphtha, liquified natural gas (LNG), liquified petroleum gas (LPG), off gas from petrochemical industries and others, comprising at least one gas permeation module with a feed gas inlet, an outlet for a gas stream containing purified methane, an outlet for a gas stream containing hydrocarbons higher than C₁ and a permselective membrane having a permeate side and a retentate side and a process for separating purified methane from hydrocarbons higher than C₁ in a feed gas mixture such as natural gas, naphtha, liquified natural gas (ING), liquified petroleum gas (LPG), off gas from petrochemical industries and others by passing the feed gas mixture under a feed gas pressure through at least one gas permeation module comprising a permselective membrane with a permeate side and a retentate side.

Natural gas, naphtha, liquified natural gas, liquified petroleum gas and others as well as some off gases from petrochemical industries usually contain high amounts of methane, Up to 90% by volume. Besides this, these gases comprise hydrocarbons higher than C₁, for instance ethane, propane, n-butane, i-butane, various pentane isomers, hexane isomers as well as so called C6+ hydrocarbons, i.e. hydrocarbons higher than C₆. The above mentioned gases may also comprise little amounts of nitrogen, carbon dioxide, hydrogen sulphide, water vapour and other odour intensive components, e.g. tetrahydrothiophene. Usually such gases are used as heating gases etc. and need not be further processed or purified. Nevertheless, for special applications there exists a need of highly purified methane, such as for the production of very pure hydrogen for e.g. metal hardening processes, the production of lead glass etc.

A process for separating methane and other higher hydrocarbons from a natural gas stream having methane as its major constituent is known from U.S. Pat. No. 4,857,078 A, wherein a rubbery permselective membrane is disclosed having a propane/methane selectivity of 8 or above such that carbon dioxide, water vapour, ethane and other higher hydrocarbons permeate through the membrane and the retentate stream is correspondingly enriched in methane. Since the rubber material of the membrane is very sensitive to mechanical pressure, this process can only be performed in a very narrow range of low feed gas pressures.

It is an object of the invention to provide a gas permeation apparatus and process for separating purified methane from a feed gas over a wide range of gas pressures in order to produce a product gas having a high content of very pure methane.

Accordingly, the gas permeation apparatus according to the invention is characterised in that said permeselective membrane consists of glassy, amorphous or semi-crystalline polymers having a glass-transition temperature above the operating temperature of the gas permeation apparatus and that said outlet for the gas stream containing purified methane is arranged on the permeate side of said permselective membrane. The membranes used in the apparatus according to the present invention have a higher permeability for methane compared to ethane, propane an other hydrocarbons higher than C₁. Thus, a comparable large amount of product gas containing methane can be withdrawn from the outlet for the gas stream containing purified methane, which is arranged on the permeate side of said permselective membrane. Surprisingly, it was found that on the permeate side of the membrane highly pure methane essentially void of hydrocarbons higher than C₁ can be obtained. Moreover, the membrane consisting of glassy, amorphous or semi-crystalline polymers provides the mechanical and thermal characteristics such that the production of a methane enriched gas mixture can be performed at a wide range of comparable high pressures. In order to ensure a reliable permeation function of the membrane the apparatus is operated at temperatures below the glass-transition temperature of these polymers.

Tests have shown that it is advantageous if the membrane of said gas permeation module consists of aromatic polyimides, aromatic polyethers or the like. Such membranes provide a selectivity of methane/ethane greater than or equal to 2.

Tests have shown that condensation of water vapour and higher hydrocarbons in the membrane can be avoided if the gas permeation apparatus has an operating temperature of between 10° C. to 100° C., preferably of between 40° C. to 60° C.

In order to control the amount of feed gas which is feed to the gas permeation module, it is of advantage if the apparatus comprises a compressor for pressurising said feed gas.

Preferably the apparatus according to the present invention is characterized in that said feed gas inlet is connected to a main line for feed gas and that said outlet for the gas stream containing hydrocarbons higher than C₁ is connected downstream to said main feed gas line in order to pass the gas stream containing hydrocarbons higher than C₁ back into the main line for feed gas. Thereby, the gas stream containing hydrocarbons higher than C₁ is fed back to the feed gas line for further use, e.g. as a fuel.

For reducing the pressure on the permeate side of the gas permeation module by which the partial pressure difference of the gas permeation module is increased, a preferred embodiment of the invention comprises a suction unit for drawing off the gas stream containing purified methane from the permeate side of said gas permeation module. The suction unit can be e.g. a fan or a compressor.

Another preferred embodiment of the present invention is characterised in that the apparatus comprises a compressor for pressurising the gas stream containing purified methane withdrawn from the permeate side of said gas permeation module. By pressurising said permeate gas, i.e. the gas stream containing purified methane, of said gas permeation module a negative pressure is produced at the permeate side of the module for drawing feed gas through the membrane. Furthermore, the pressurised permeate gas containing purified methane may be supplied to a high pressure application.

In order to separate carbon dioxide and other components from the feed gas, which have a higher permeability through the polymer membranes, it is favourable if the gas permeation apparatus comprises a further superposed gas permeation module, which is connected to the feed gas inlet of the gas permeation module. In order to separate different gases of a gas mixture in a superposed gas permeation module, the membrane materials of the superposed gas permeation module and the gas permeation module may be same or different, depending on the components of the feed gas to be separated by the superposed gas permeation module.

If a retentate gas duct of the superposed gas permeation module is connected with the feed gas inlet of said gas permeation module, the retentate gas of a superposed gas permeation module can be directly supplied to the feed gas side of the gas permeation module.

Since the permeability ratio of CO₂ and other components to be separated by the superposed gas permeation module is usually significantly higher than the permeability ratio of methane, which is separated and purified by the actual production gas permeation module, it is favourable if the sizes of the membranes of said superposed gas permeation module and of said gas permeation module are different.

Due to the pressure on the retentate side of gas permeation modules being significantly higher than on the permeate side, the retentate gas of the actual production gas permeation module can be used for usual applications as well as the permeate gas of the further, superposed gas permeation module. Accordingly, it is favourable if the outlet for the gas stream containing hydrocarbons higher than C₁, i.e. the retentate gas outlet of said gas permeation module, is connected via a duct comprising a pressure-reducing valve with a permeate gas duct of said superposed gas permeation module.

If the apparatus comprises a plurality of gas permeation modules which are arranged in parallel, the amount of produced product gas can be controlled depending on the number of parallel arranged gas permeation modules.

If the apparatus comprises a plurality of gas permeation modules which are arranged in series, the product gas of a superposed gas permeation module can be used as feed gas for a following gas permeation module, in order to enrich step by step the concentration and purity of methane in the product gas mixture.

The process for separating purified methane from hydrocarbons higher than C₁ in a feed gas mixture such as natural gas, naphtha, liquified natural gas (LNG), liquified petroleum gas (LPG), off gas from petrochemical industries and others, comprising at least one gas permeation module with a permselective membrane having a permeate side and a retentate side, is characterised in that a product gas mixture essentially void of hydrocarbons higher than C₁ is withdrawn from the permeate side of the membrane. It was surprisingly found that purification of methane from a gas mixture can reliably be provided on the permeate side, although a plurality of membrane materials are known from prior art which all have a higher permeability for higher hydrocarbons than for methane.

In order to avoid transition of the polymer material of the membrane to the plastic phase, by which the permeation function of the membrane would be significantly affected, it is of advantage if the process is performed at a temperature lower than the glass-transition temperature of the membrane of the gas permeation module.

Tests have shown that the purification process works most efficiently if the process is performed at a temperature between 10° C. to 100° C., preferably between 40° C. to 60° C., since condensation of water vapour and higher hydrocarbons in the membrane can be avoided.

For a reliable permeation of the feed gas mixture through the gas permeation module it is advantageous if the feed gas pressure is higher than 1 bar.

If the feed gas mixture is the retentate product gas of a superposed gas permeation module, gases having a higher permeability through the membrane of the gas permeation module, such as carbon dioxide, water vapour, nitrogen and others, can be separated by the superposed gas permeation module and the retentate product gas of this superposed permeation can be used as a feed gas for the actual production permeation in order to produce a methane enriched gas mixture essentially void of hydrocarbons higher than C₁.

For a further use of the gases having a higher content of hydrocarbons higher than C₁, it is of advantage if the permeate product gas of said superposed gas permeation module and the retentate product gas of said gas permeation module are combined.

The invention will be explained now in more detail by way of reference to the accompanying drawing figures in which:

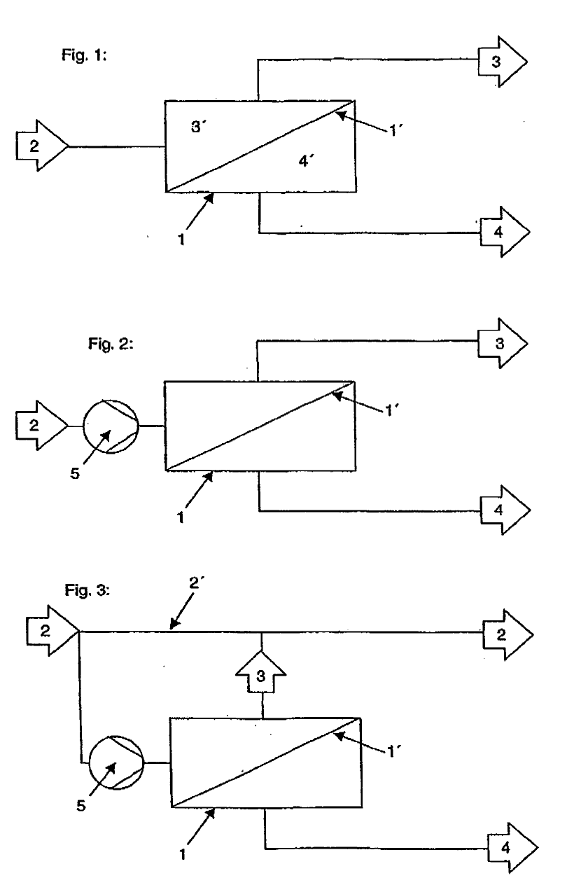

FIG. 1 shows a schematic view of a process and an apparatus, respectively, for separating purified methane as a permeate product gas;

FIG. 2 shows an apparatus similar to the apparatus shown in FIG. 1, wherein a compressor is provided for pressurising feed gas for the gas permeation module;

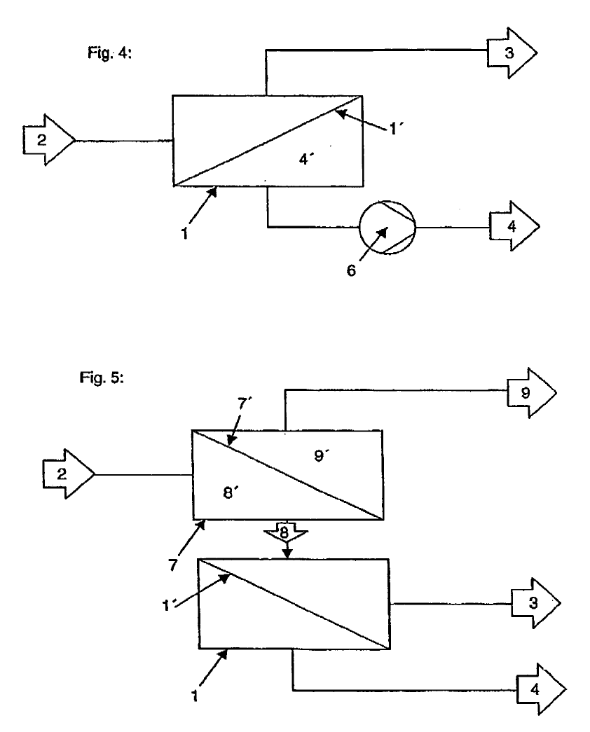

FIG. 3 shows a schematic view of a process and an apparatus, respectively, similar to FIGS. 1 and 2, in which the retentate gas is fed back to a main gas line;

FIG. 4 shows a schematic view of a process and an apparatus, respectively, similar to FIGS. 1 and 2, with a suction unit, e.g. a compressor for drawing off the permeate gas,

FIG. 5 shows a process and an apparatus, respectively, where a further gas permeation module is superposed to the gas permeation module, in order to separate nitrogen, water vapour, carbon dioxide and other components from the feed gas for the gas permeation module;

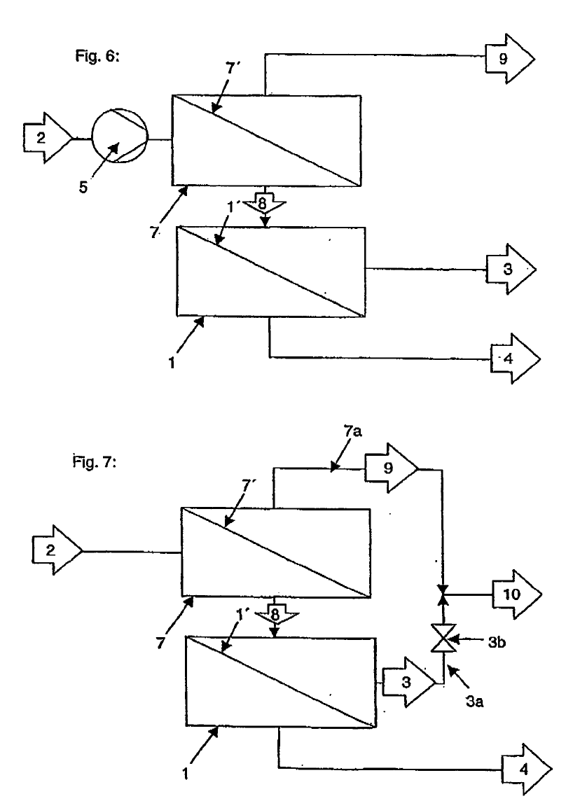

FIG. 6 shows a process and an apparatus, respectively, similar to FIG. 5 with a compressor for pressurising the feed gas of the superposed gas permeation module; and

FIG. 7 shows a process and an apparatus, respectively, where the retentate gas of the gas permeation module for separating purified methane is combined with the permeate gas of a superposed gas permeation module.

FIG. 1 shows schematically a process and an apparatus, respectively, where a gas permeation module 1 is provided for purifying a feed gas mixture 2 by a permselective membrane 1′, in order to produce a permeate product gas 4 which is essentially void of hydrocarbons higher than C₁ on the permeate side 4 of the gas permeation module 1. On the retentate side 3′ of the gas permeation module 1 a retentate product gas 3 can be withdrawn.

The permselective membrane 1′ consists of polymers having a higher permeability for methane compared to ethane, propane and other higher hydrocarbons. These polymers may be glasslike, amorphous, partly crystalline polymers which are used at a temperature lower than their glass-transition temperature (i.e. the temperature at which polymers change from the amorphous glass-like phase into the plastic phase). Thus, the membrane 1′ of the gas permeation module 1 may consist of aromatic polyimides, aromatic polyethers or the like. The use of these polymers through which methane permeates preferably compared to higher hydrocarbons provides the possibility to withdraw retentate gas 3 at a pressure similar to the pressure of the feed gas 2.

As it can be seen in FIG. 2, feed gas 2 may be pressurised by compressor 5 in order to control permeation speed through the membrane 1′ and thus the production amount of permeate gas 4 essentially void of hydrocarbons higher than C₁ having a high methane concentration can be controlled.

From FIG. 3 it can be seen that feed gas 2 is branched off from a main feed gas line 2′, pressurized by compressor 5 and introduced into the gas permeation module 1. The retentate gas 3, having essentially the same pressure as the feed gas 2, is then conveyed back to the main feed gas line 2′ without substantial need of further compression. Permeate gas 4 being essentially void of hydrocarbons higher than C₁ and having a high methane concentration is withdrawn from the permeate side of membrane 1′.

FIG. 4 shows schematically a very similar process and apparatus, respectively, to FIGS. 1 and 2, with a suction unit, here a compressor 6, provided on the permeate side 4′of the gas permeation module 1. By the compressor 6 both feed gas 2 is sucked through the permselective membrane 1′ and the permeate product gas 4 is pressurised, which may be favourable for further treatments or applications of the permeate product gas 4.

In FIG. 5 another preferred embodiment of the invention is shown, where a further gas permeation module 7 is superposed on the actual production gas permeation module 1, in order to separate components from the feed gas mixture 2 which would easier permeate through the permselective membrane 1′. Accordingly, membrane 7′ of the gas permeation module 7 is able to separate components, such as carbon dioxide, nitrogen, water vapour, which can be withdrawn together with some methane as permeate gas 9 on the permeate side 9′ of the superposed gas permeation module 7. The retentate gas 8, which is withdrawn on the retentate side 8′ of the superposed gas permeation module 7, is a gas mixture with a highly reduced concentration of the components which were separated by the membrane 7′ and is therefore suitable to be used as feed gas for the gas permeation module 1. By way of this two-step purification of feed gas 2, which may be natural gas, liquified natural gas, liquified petroleum gas, naphtha, off gases from petrochemical industries and other gases having methane as main component, a permeate product gas 4 consisting essentially of methane of highest purity and concentration can be obtained.

As it is shown in FIG. 6, a compressor 5 may be arranged on the feed gas side of the superposed gas permeation module 7 in order to control the gas pressure of feed gas 2.

In FIG. 7 a further combination of a superposed gas permeation module 7 and the actual production gas module 1 is shown, where the retentate gas 3 of the production gas permeation module 1 is combined with the permeate gas 9 of the superposed gas permeation module 7. Since the pressure on the permeate side of gas permeation modules 1 and 7, respectively, is significantly lower than the pressure on the retentate side of the gas permeation modules 1, 7, a pressure reducing valve 3b is interposed in retentate gas duct 3a of the production gas permeation module 1. In order to realise the process as it is shown in FIG. 7, the retentate gas 8 of the superposed gas permeation module 7 is introduced as a feed gas into the production gas permeation module 1. For combining product gas streams 3 and 9, retentate gas duct 3a is connected with the permeate gas duct 7a of the superposed gas permeation module 7, in order to achieve a single gas stream 10 containing virtually all the hydrocarbons higher than C₁, carbon dioxide, water vapour, nitrogen etc. Furthermore, one can also convey the—optionally pressurized—gas strewn 10 to a main gas conduit system without any problems.

Of course, a plurality of gas permeation modules 1 and 7, respectively, can be arranged in parallel in order to control the amount of product permeate gas 4 which is produced on the other side, a plurality of gas permeation modules 1 and 7, respectively may be arranged in series in order to control the level of pre-purification of the feed gas and thereby the concentration and purity of methane in the permeate gas mixture 4.

The results of a process according to the present invention by using the gas permeation apparatus according to the present invention are given in the following table:

Gas Permeation Module:

| | |
|---|---|
| Length (mm) | 610 |
| Diameter (mm) | 50 |
| Housing material: | Aluminum |
| Membrane material: | Polyimide |
| Feed source: | Natural gas provided by Wiengas (AT) |

Results:

| Feed gas | | Permeate (Product) | | Retentate | |
|---|---|---|---|---|---|
| Flow (1/min) | 34.5 | Flow (1/min) | 1.5 | Flow (1/min) | 33 |
| Pressure (bar) | 5.2 | Pressure (bar) | 1 | Pressure (bar) | 5.1 |
| T (° C.) | 56 | T (° C.) | 56 | T (° C.) | 56 |

| Gas analysis | | | Gas analysis | | | Gas analysis | | |
|---|---|---|---|---|---|---|---|---|
| O₂ | Vol % | 0.00 | O₂ | Vol % | 0.00 | O₂ | Vol % | 0.00 |
| N₂ | Vol % | 0.60 | N₂ | Vol % | 0.77 | N₂ | Vol % | 0.58 |
| CH₄ | Vol % | 97.98 | CH₄ | Vol % | 97.83 | CH₄ | Vol % | 97.92 |
| CO₂ | Vol % | 0.00 | CO₂ | Vol % | 0.98 | CO₂ | Vol % | 0.00 |
| C₂H₆ | Vol % | 0.87 | C₂H₆ | Vol % | 0.37 | C₂H₆ | Vol % | 0.87 |
| C₃H₈ | Vol % | 0.18 | C₃H₈ | Vol % | 0.02 | C₃H₈ | Vol % | 0.18 |
| i-Bu | Vol % | 0.07 | i-Bu | Vol % | 0.00 | i-Bu | Vol % | 0.07 |
| n-Bu | Vol % | 0.07 | n-Bu | Vol % | 0.00 | n-Bu | Vol % | 0.07 |
| C₅H₁₂ | Vol % | 0.07 | C₅H₁₂ | Vol % | 0.01 | C₅H₁₂ | Vol % | 0.07 |
| C₆H₁₄ | Vol % | 0.16 | C₆H₁₄ | Vol % | 0.02 | C₆H₁₄ | Vol % | 0.24 |

i−Bu=Isobutane; n−Bu=n−Butane

Amount of hydrocarbons higher than C₁:

| Feed gas: | | | Permeate (Product): | | | Retentate: | | |
|---|---|---|---|---|---|---|---|---|
| C2+ | Vol % | 1.42 | C2+ | Vol % | 0.42 | C2+ | Vol % | 1.50 |

Finally, it may be mentioned that the process and the apparatus according to the invention may also be used to selectively separate sulphuric compounds, e.g. mercaptene, thiophene, etc. for producing gases with a very low sulphuric concentration as it is useful for certain specialised applications.

1. Gas permeation apparatus for separating purified methane from hydrocarbons higher than C₁ in a feed gas mixture such as natural gas, naphtha, liquified natural gas (LNG), liquified petroleum gas (LPG), off gas from petrochemical industries and others, comprising at least one gas permeation module (1) with a feed gas inlet, an outlet for a gas stream (4) containing purified methane, an outlet for a gas stream (3) containing hydrocarbons higher than C₁ and a permselective membrane (1′) having a permeate side (4′) and a retentate side (3′), characterised in that said permselective membrane (1′) consists of glassy, amorphous or semi-crystalline polymers having a glass-transition temperature above the operating temperature of the gas permeation apparatus and that said outlet for the gas stream (4) containing purified methane is arranged on the permeate side (4′) of said permselective membrane (1′).

2. Gas permeation apparatus according to claim 1, characterized in that the membrane (1′) of said gas permeation module (1) consists of aromatic polyimides, aromatic polyethers or the like.

3. Gas permeation apparatus according to claim 1 or 2, characterised in that the gas permeation apparatus has an operating temperature of between 10° C. to 100° C., preferably between 40° C. to 60° C.

4. Gas permeation apparatus according to any one of claims 1 to 3, characterised in that the apparatus comprises a compressor (5) for pressurising said feed gas (2) before passing to the feed gas inlet.

5. Gas permeation apparatus according to claim 4, further characterised in that said feed gas inlet is connected to a main line (2′) for feed gas (2) and that said outlet for the gas stream (3) containing hydrocarbons higher than C₁ is connected downstream to said main feed gas line (2′) in order to pass the gas stream (3) containing hydrocarbons higher than C₁ back into the main line (2′) for feed gas (2).

6. Gas permeation apparatus according to any of claims 1 to 5, characterised by a suction unit (6) for drawing off the gas stream (4) containing purified methane from the permeate side (4′) of said gas permeation module (1).

7. Gas permeation apparatus according to claim 6, characterised in that said suction unit (6) is a compressor for further pressurising the gas stream (4) containing purified methane withdrawn from the permeate side (4′) of said gas permeation module (1).

8. Gas permeation apparatus according to any of claims 1 to 7, characterised by a further superposed gas permeation module (7) being connected to the feed gas inlet of the gas permeation module (1).

9. Gas permeation apparatus according to claim 8, characterised in that the retentate gas outlet of the superposed gas permeation module (7) is connected to the feed gas inlet of said gas permeation module (1) in order to pass the retentate gas stream (8) of the superposed gas permeation module (7) into said gas permeation module (1).

10. Gas permeation apparatus according to claim 8 or 9, characterised in that the sizes of the membranes (1′, 7′) of said superposed gas permeation module (7) and of said gas permeation module (1) are different.

11. Gas permeation apparatus according to any one of claims 8 to 10, characterised in that the outlet for the gas stream (3) containing hydrocarbons higher than C₁ of said gas permeation module (1) is connected via a duct (3a) comprising a pressure-reducing valve (3b) with a permeate gas duct (7a) of said superposed gas permeation module (7).

12. Gas permeation apparatus according to any one of claims 1 to 11, characterised in that the apparatus comprises a plurality of gas permeation modules (1) which are arranged in parallel.

13. Gas permeation apparatus according to any one of claims 1 to 12, characterised in that the apparatus comprises a plurality of gas permeation modules (1) which are arranged in series.

14. Process for separating purified methane from hydrocarbons higher than C₁ in a feed gas mixture such as natural gas, naphtha, liquified natural gas (LNG), liquified petroleum gas (LPG), off gas from petrochemical industries and others, comprising at least one gas permeation module (1) with a permselective membrane (1′) having a permeate side (4′) and a retentate side (3′), characterised in that a product gas mixture (4) essentially void of hydrocarbons higher than C₁ is withdrawn from the permeate side (4′) of the membrane (11).

15. Process according to claim 14, characterised in that the process is performed at a temperature lower than the glass-transition temperature of the membrane (1′) of the gas permeation module (1).

16. Process according to claim 14 or 15, characterised in that the process is performed at a temperature between 10° C. to 100° C., preferably between 40° C. to 60° C.

17. Process according to any one of claims 14 to 16, characterised in that the feed gas pressure is higher than 1 bar.

18. Process according to any one of clams 14 to 17, characterised in that the feed gas mixture (2) is the retentate product gas (8) of a superposed gas permeation module (7).

19. Process according to claim 18, characterised in that the permeate product gas (9) of said superposed gas permeation module (7) and the retentate product gas (3) of said gas permeation module (1) are combined.
